(19) United States
(12) Patent Application Publication
(10) Pub. No.: US 2026/0100641 A1
(43) Pub. Date: Apr. 9, 2026

(54) POWER FACTOR CORRECTED POWER SUPPLY WITH SMALL BUS CAPACITOR

(71) Applicant: Current Lighting Solutions Canada Inc., Lachine (CA)

(72) Inventor: Frantz Emmanuel Robinson, Montreal (CA)

(21) Appl. No.: 19/353,832

(22) Filed: Oct. 9, 2025

Related U.S. Application Data
(60) Provisional application No. 63/705,128, filed on Oct. 9, 2024.

(51) Int. Cl. H02M 1/42; H02M 1/00

(52) U.S. Cl. CPC H02M 1/4275; H02M 1/0016; H02M 1/0025; H02M 1/425; H02M 1/4266

(57) ABSTRACT

A Power Factor Correction (PFC) circuit that includes an unusually low value output bus capacitor is disclosed. In an embodiment, the PFC circuit includes a rectifier bridge circuit, a PFC power stage, a PFC control segment, and the small value, high-voltage capacitor. In some embodiments, the PFC control segment includes a PFC controller and a digital signal processor (DSP), and the DSP is configured to convert an high AC ripple feedback signal received from the high-voltage feedback divider to a digital high ripple feedback digital signal, transform the digital high ripple feedback digital signal to a suitable low-ripple feedback signal, convert the digital low-ripple feedback signal to an AC low-ripple feedback signal, and input the analog low-ripple feedback signal to the PFC control segment enabling the PFC circuit to operate correctly and reliably even though use of the low value output bus capacitor results in the presence of a very high AC ripple on the output voltage.

### CROSS REFERENCE

The present invention application is a non-provisional patent application claiming priority to provisional application serial No. 63/705,128, which was filed on October 9, 2024, the content of which is incorporated by reference herein in its entirety.

### FIELD OF THE INVENTION

The present disclosure generally relates to a Power Factor Correction (PFC) circuit that includes an unusually low value output bus capacitor. More particularly, the novel PFC circuit functions correctly and reliably even though use of the unusually low value output bus capacitor results in the presence of a very high AC ripple on the output voltage, which would also normally appear on the PFC controller voltage feedback node leading to erratic or unstable operation.

### BACKGROUND

In many power supply use cases such as solid-state outdoor lighting, an extended service life of 10 or 15 years or more, and very high reliability under harsh environmental conditions, is required. Power factor correction (PFC) is also mandated by applicable regulations. In a PFC circuit, the weakest link in achieving long life and reliability is the (electrolytic) output bus capacitor. Generally, other types of capacitors that would perform better under harsh conditions are unsuitable either because of the rather high voltages applied in this function (typically 400V to 500V or higher) and/or the very large value of capacitance, which is required to effectively reduce the resulting ripple to a level acceptable to the PFC controller feedback requirements. Only electrolytic capacitors have a high enough capacitance density and acceptably low cost in those sizes to be practical in size and viable in cost for such applications.

Many power supply designs that include power factor correction are 2-stage power converters, where the PFC circuit comprises the first stage, and a second DC-DC converter stage (which can be of many topologies) further regulates the output voltage to a much lower and tightly controlled level for the end-equipment and devices that are powered by it. This second stage can be designed to tolerate a much larger degree of AC ripple than typically present on the output of a PFC circuit and still maintain tight regulation on their final output. While this appears to make it possible to replace the large electrolytic capacitor on the output of the PFC circuit with a much smaller one (by an order of magnitude or more) and as a result allow the use of much longer life/higher reliability capacitor types, in practice this does not work because of the simple nature of present day PFC controller technology, which are not designed to work with such high levels of resulting ripple on their feedback inputs.

The inventor recognized that it would be advantageous and/or beneficial to replace the conventional PFC boost circuit with an improved version that could function correctly and reliably, even in the presence of very high AC ripple at the PFC controller voltage feedback node resulting from having such an unusually small bus capacitance. Such a novel PFC circuit makes it possible to shrink the PFC output DC bus capacitor enough to make it viable to use a long-life film type capacitor in place of an electrolytic type, even in very space and cost constrained applications such as lighting. Such a PFC power supply would thus allow much improved reliability, durability, and/or lower cost to be achieved.

### SUMMARY OF THE INVENTION

Presented are Power Factor Correction (PFC) circuit apparatus and methods, wherein one of the components of the PFC circuit is an unusually low value output bus capacitor. In accordance with disclosed PFC circuit embodiments, a higher reliability, longer-life film type capacitor may be used in place of an electrolytic type capacitor that is typically utilized. In accordance with the invention, the PFC circuit functions correctly and reliably even though the unusually low value output bus capacitor presents a very high AC ripple at a PFC controller voltage feedback node.

In some embodiments, the PFC circuit includes an input rectifier block, a power stage (typically of a boost type consisting of an inductor, MOSFET (transistor switch) and diode, but the power stage may have other topologies), a controller segment (which may include an integrated circuit (IC) controller), an output smoothing filter (which may consist of a relatively large electrolytic capacitor), and a voltage feedback network connected between the PFC controller and output capacitor.

In some embodiments, the voltage feedback network consists of a resistive voltage divider, optionally followed by a simple resistor-capacitor low pass filter. In applications where the downstream circuitry can tolerate a higher degree of (2x power line frequency) ripple on the DC power bus (for example, for an outdoor solid-state lighting fixture), the disclosed PFC circuit makes it possible to drastically reduce the PFC output capacitance value. In some applications, the disclosed PFC circuit may enable a higher reliability, longer life film type capacitor to be used instead of electrolytic types that are typically utilized. The PFC circuit in accordance with the invention provides a novel improvement to the PFC feedback network allowing the control segment to operate correctly in spite of the presence of high AC ripple in the feedback signal due to the reduced capacitance of the output filter.

Embodiments of the PFC circuit may include a digital signal processor (DSP) or microcontroller (MCU) acting as a DSP, operably connected between the output feedback voltage divider and the PFC controller. The DSP or MCU replaces the simple RC low-pass filter and a low bandwidth filter. In this configuration, the PFC controller processes a high ripple feedback signal from the small value output capacitor in a manner that permits the PFC circuit to perform in an optimal manner.

In another aspect, a method for operating a Power Factor Correction (PFC) device having a small value output capacitor is presented. In an embodiment, the process includes receiving, by a digital signal processor (DSP) from a high-voltage feedback divider circuit, a high AC ripple feedback signal generated by a small value output capacitor, and then converting, by the DSP, the high AC ripple feedback signal to a digital high ripple feedback digital signal. The method continues with the DSP transforming the digital high ripple feedback digital signal to a suitable low-ripple feedback signal, next converting the digital low-ripple feedback signal to an analog low-ripple feedback signal, and then outputting the analog low-ripple feedback signal to a PFC control segment, which enables the PFC device to operate correctly and reliably.

In yet another aspect, a non-transitory computer-readable medium stores instructions which, when executed by a digital signal processor (DSP) of a Power Factor Correction (PFC) device that utilizes a small value output capacitor, permits the PFC device to operate correctly and reliably. In particular, the non-transitory computer-readable medium stores instructions, when executed by the DSP causes the DSP to receive, from a high-voltage feedback divider circuit of the PFC device, a high AC ripple feedback signal generated by a small value output capacitor, convert the high AC ripple feedback signal to a digital high ripple feedback digital signal, transform the digital high ripple feedback digital signal to a suitable low-ripple feedback signal, convert the digital low-ripple feedback signal to an analog low-ripple feedback signal, and then output the analog low-ripple feedback signal to a PFC control segment of the PFC device enabling the PFC device to operate correctly and reliably.

It should also be understood that in yet other embodiments, the digital signal processing function may be incorporated into the PFC controller directly, or the PFC controller function may also be provided by the DSP circuit using a single integrated circuit (IC). Other implementations may also utilize analog signal processing blocks (such as op-amps) although in some cases some diminishment in circuit performance may occur.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1A is a simplified block diagram of conventional “Boost” power factor correction (PFC) circuit;

FIG. 1B is a circuit diagram illustrating another example of a conventional power factor correction (PFC) circuit;

FIG. 2 is a circuit diagram of an embodiment of a Boost PFC converter in accordance with some embodiments of the disclosure;

FIG. 3 illustrates another embodiment of a PFC converter circuit according to some embodiments of the disclosure;

FIG. 4 illustrates yet another embodiment of a PFC converter circuit according to some embodiments of the disclosure; and

FIG. 5 is a flowchart illustrating an embodiment of a DSP algorithm (or DSP code) in accordance with some embodiments of the disclosure.

### DETAILED DESCRIPTION

Reference now will be made in detail to illustrative embodiments, one or more examples of which are illustrated in the drawings. Like components and/or items in the various drawings may be identified by the same reference number, and each example is provided by way of explanation only and thus does not limit the invention. In fact, it will be apparent to those skilled in the art that various modifications and/or variations can be made without departing from the scope and/or spirit of the invention. For instance, in many cases features illustrated or described as part of one embodiment can be used with another embodiment to yield a further embodiment. Thus, it is intended that the present disclosure covers such modifications and variations as come within the scope of the appended claims and their equivalents.

In general, and for the purpose of introducing concepts of embodiments of the present invention, apparatus and methods are disclosed for a Power Factor Corrected (PFC) AC-DC or DC-DC converter device (which may be a boost, non-isolated converter) that is configured for providing optimal performance. In some embodiments, the term “optimal performance” may be defined as achieving a target power factor of over ninety-percent (90%) and a Total Harmonic Distortion (THD) lower than 20% under all input and output and environmental conditions, wherein the THD value numerically describes the level of distortion to the AC line current (THD is equal to the root mean square of the input current at each harmonic frequency divided by the root-mean-square (RMS) input current at the fundamental line frequency).

The PFC converter disclosed herein includes a bus capacitor having a low capacitance value (for example, one-tenth (1/10) to one-twentieth (1/20) of the value usually required for a conventional PFC converter to work well), which results in a very high 120 Hertz (Hz) ripple being present on the output voltage (on the order of 50% to 80% of the maximum DC voltage). This high ripple value must be attenuated or removed from the PFC controller feedback path because otherwise such a high ripple value can lead to very poor (unacceptable) power quality (PF/THD), loss of regulation, instability and/or erratic operation of the PFC controller integrated circuit (IC). However, the ripple reduction must be accomplished without materially altering the “DC” voltage component of the feedback signal, in order to maintain stable and reliable operation of the PFC controller device. Notably, introducing a significant group delay to that signal, as would be the result of simple passive / analog filtering, would not be acceptable and generally would result in erratic / unstable operation in at least some corner cases of operational range. Thus, PFC converter device embodiments disclosed herein exploit more advanced Digital Signal Processing (DSP) techniques employed in a unique feedback filtering approach that operates to remove or largely attenuate the 120 Hz ripple of the very low capacitance value DC bus capacitor without otherwise significantly altering or distorting the essential part of that feedback signal required to maintain stable operation of the PFC controller under all conditions. The DSP stage can advantageously support a more complex transfer function than ordinarily possible or practical with discrete and/or analog-only designs. Thus, instead of using a voltage regulation feedback path in the PFC converter that includes a resistive voltage divider with or without analog (R-C) filtering (with or without gain) incorporated into the divider network (or added to the feedback compensation node of the PFC IC itself), the DSP stage essentially replaces or augments such circuitry.

In some implementations according to the present disclosure, the required transfer function(s) may be incorporated within software or processor-executable instructions which cause a controller (which may be referred to as a PFC controller, and which PFC controller may be an integrated circuit (IC)) to permit the PFC converter device to operate “normally.” Such operation essentially “hides” the very large 120Hz ripple from the PFC controller IC while preserving and/or augmenting the essential DC and higher frequency feedback signal required for the PFC converter device to maintain stable operation and very good power factor with low THD. Examples of other implementations are also disclosed herein below.

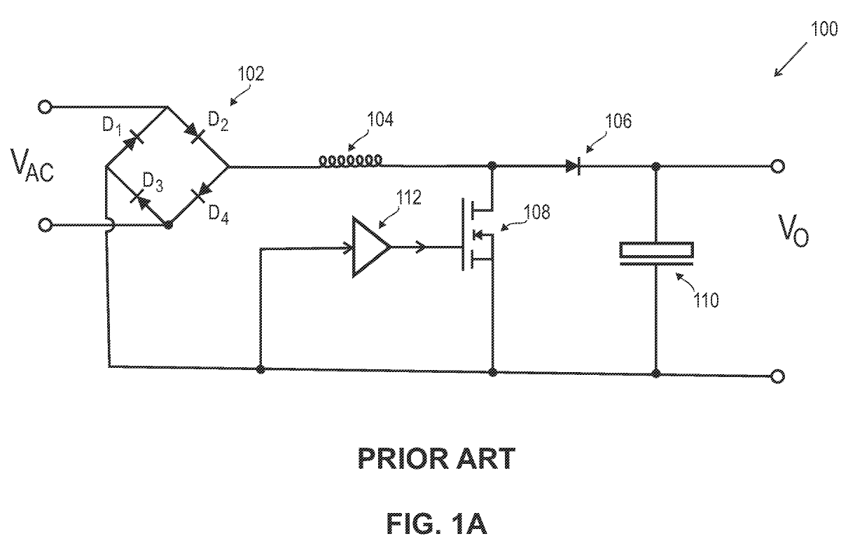

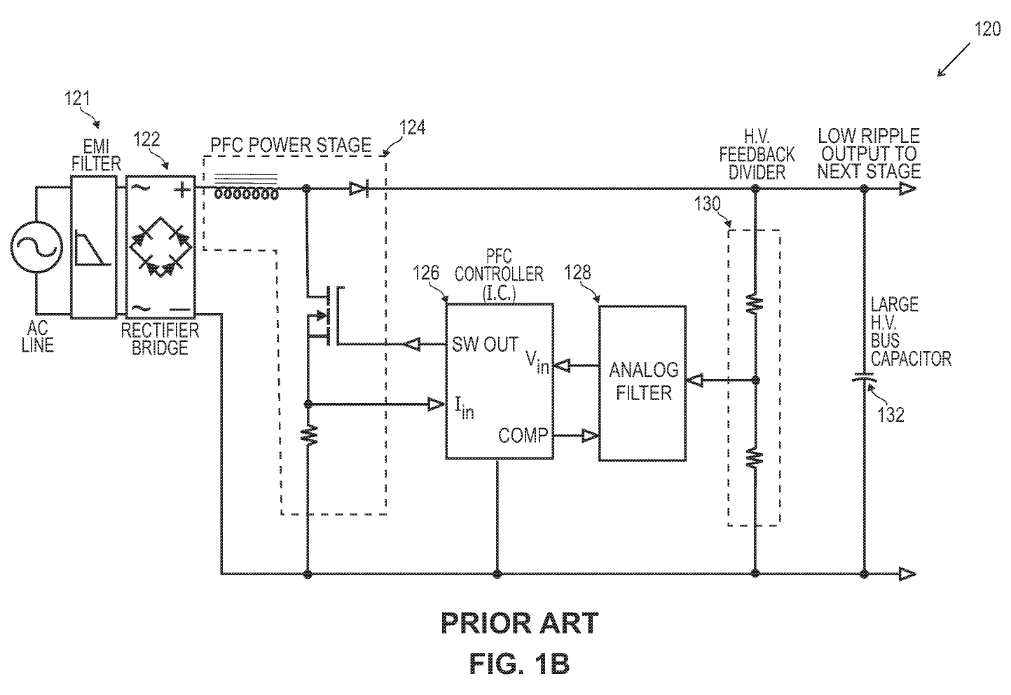

FIG. 1A is a simplified block diagram of conventional “Boost” PFC circuit 100, which is an active power factor correction (PFC) circuit. The rectifying bridge circuit 102 includes four rectifying diodes D₁, D₂, D₃ and D₄ and in this example is connected to alternating current (AC) input (V_{ac}), which can span a wide range of voltages (typically in a range of 80V to 305V). The rectifying bridge circuit 102 converts the incoming AC voltage to a pulsating DC voltage at 120 Hz. This rectified pulsating DC signal is then presented to a large inductor 104, which is operatively connected to a switching transistor 108 (which may be a MOSFET). During operation, the switching transistor 108 switches ON and OFF, and when it is ON then a large pulse of current builds up through the inductor 104 and when it is OFF then the current flows through the diode 106 and into the large electrolytic capacitor 110 which starts charging. The electrolytic capacitor 110 functions to filter and/or smooth the output voltage V₀ to provide an even voltage for the downstream circuitry (for example, power input to a lighting fixture). The electrolytic capacitor 110 must typically be able to withstand an input voltage on the order of 400V or above to ensure a good power factor (PF) and also be capable of filtering out the high frequency current (ripple) before it is fed back into the feedback amplifier 112 to ensure proper operation of the PFC circuit 102. It should be understood that, in some implementations of such a Boost PFC circuit a PFC controller IC is utilized to perform such operations.

Referring again to FIG. 1A, in some cases the electrolytic capacitor 110 may be a physically large device and may be rated, for example, as a 100 micro-Farad capacitor. In view of the circuit requirements, some electronics manufacturers produce large electrolytic capacitors that can withstand a voltage in the range of 350-500 V and handle a high ripple current, but such components are typically only expected to have a 1000 hour to 10,000 hour useful life at rated temperature and degrade rapidly at ambient temperature extremes. Moreover, due to their use of a wet, corrosive electrolyte, such capacitors are vulnerable to several failure modes that strongly reduce their long-term reliability and cap useful life expectancy to less than 10 years even under best case conditions.

FIG. 1B is a circuit diagram illustrating another example of a conventional power factor correction (PFC) circuit 120. At the input is an electromagnetic interference (EMI) filter 121 which reduces conducted electromagnetic interference by providing high impedance at high frequencies to block noise. Operatively connected to the EMI filter 121 is rectifying bridge circuitry 122 which includes four rectifying diodes that operate to convert the incoming AC voltage into pulsating DC voltage at 120 Hz. This rectified, pulsating DC voltage is operatively connected to a PFC power stage 124. The PFC power stage 124 is operatively connected to a PFC controller (which may be an integrated circuit) 126, which in turn is operatively connected to an analog filter 128. A high-voltage feedback divider circuit 130 is also operatively connected to the PFC controller 126 and operatively connected to a large high-voltage bus capacitor 132.

During operation the PFC controller operates to control the current (drawn from the power line in proportion to the line voltage) and provided to the large electrolytic capacitor 132, which functions to filter and/or smooth the output voltage (V₀) to provide an even voltage for the downstream circuitry (for example, power input to a lighting fixture). The electrolytic capacitor 110 must typically be able to withstand an input voltage on the order of 400V or above and also be capable of filtering out the high frequency current (ripple) before it is fed back to the analog filter 128 and PFC controller 126 to ensure proper operation of the PFC circuit 120. In this embodiment the PFC controller 126 may be an integrated circuit (IC) controller.

As mentioned above, the electrolytic capacitor 110 may be a physically large device and may be rated, for example, as a 100 micro farad capacitor. In view of the PFC circuit requirements, the large value electrolytic capacitor 110 may be rated for withstanding a voltage in the range of 350-500 V and must also be rated to handle a high ripple current, but such components typically have a 1000 hour to 10,000 hour useful life at rated temperature and can degrade rapidly at ambient temperature extremes. Moreover, such electrolytic capacitors are vulnerable to several failure modes that can reduce their long-term reliability and cap their useful life expectancy to less than 10 years.

Thus, disclosed are novel PFC converter embodiments that include circuitry and/or one or more additional modules and/or modifications that enable replacement of the large electrolytic capacitor found in conventional PFC converters with a much smaller value (on the order of 10 microfarads) thin-film capacitor. The metallized-film capacitor advantageously has greatly superior reliability and temperature stability characteristics, and supports a much longer operating lifetime as compared to electrolytic types, on the order of 50K hours to over 1 million hours at 70C, providing a potential life improvement by an order of magnitude. In addition, in some embodiments utilizing such a low value capacitor, one or more additional modules and/or components may be inserted into the voltage and/or current feedback network of the PFC converter. In some other implementations, an integrated circuit (IC) or system may be utilized which directly controls the PFC power stage without the need to use a distinct and separate “dedicated” PFC controller IC or subsystem. In such cases, the IC or system may incorporate digital signal processing hardware and/or software, which may include processor-executable instructions (i.e., software) which when executed by a controller (such as a microprocessor) mitigates and/or eliminates the negative effects of the very high 120Hz ripple (for a 60Hz power system, or 100Hz ripple when used on a 50Hz power system) that is present on the output voltage and regulation feedback network during operation of the PFC converter.

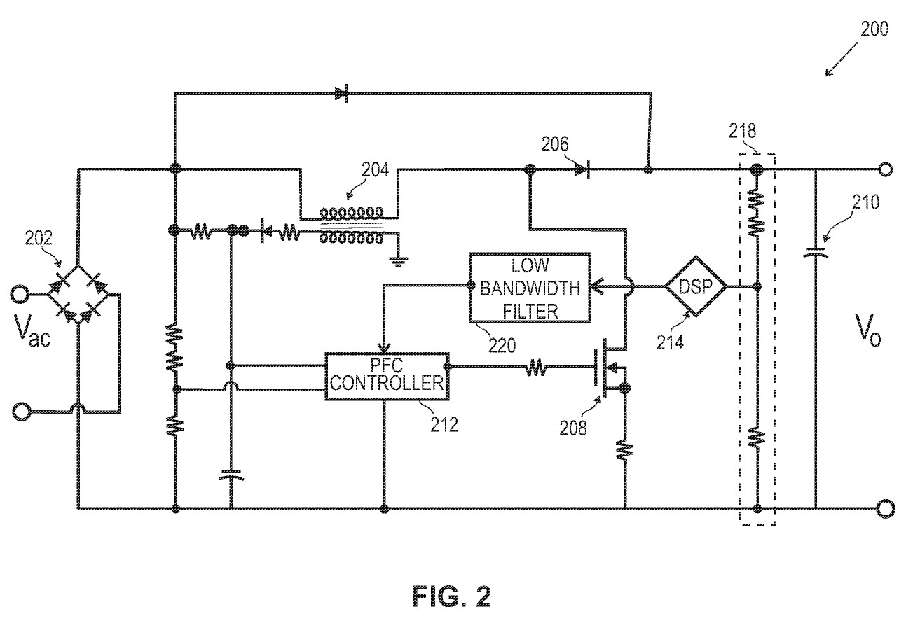

FIG. 2 is a simplified circuit diagram of an embodiment of a Boost PFC converter 200 in accordance with some embodiments. The rectifying bridge circuit 202 includes four rectifying diodes D₁, D₂, D₃ and D₄ and is connected to alternating current (AC) input (V_{ac}), which can span a wide range of voltages. As explained above with regard to FIG. 1A, the rectifying bridge circuit 202 operates to convert the incoming AC voltage to a pulsating DC voltage to the following PFC power stage. The PFC power stage consists of a large inductor 204, which is operatively connected to a switching transistor 208 (which may be a MOSFET). During operation, the switching transistor 208 switches ON and OFF, and when it is ON then a large pulse of current builds up through inductor 204. When the switching transistor 208 is OFF then the current flows through the diode 206 and into a small value capacitor 210 which starts charging. The small value capacitor 210 filters and/or smooths the output voltage V₀ to provide an even voltage for the downstream circuitry (for example, power input to a computer printer or the like) and is capable of withstanding an input voltage on the order of 400V or above to ensure a good power factor (PF), but it is not capable of filtering out the low frequency 120 Hz voltage (ripple) before it is fed back into the PFC Controller 212 (which can cause the PFC circuit 200 to fail to operate correctly). Thus, as shown in this example, a digital signal processor (DSP) 214 is inserted between a voltage divider circuit 216 and an input to the PFC controller 212 (here, via a low bandwidth filter 220). The DSP 214 functions to eliminate or minimize the 120 Hz ripple component of the feedback signal without otherwise altering the essential features of the signal so that the PFC converter 200 can operate as expected.

Referring again to FIG. 2, a number of different methods may provide equivalent results when applied in software in the DSP 214 depending on the exact implementation of the PFC controller. For example, if an alternate PFC converter circuit configuration is used, then the DSP 214 may take the input signal from the voltage divider 218 and convert it from analog to digital, conduct processing in the digital domain and then convert the resulting digital signal back to an analog signal and feed it directly to the PFC controller 212 for further processing. Other suitable implementations may be implemented utilizing an effective DSP algorithm in software and/or firmware, and variations upon them can work correctly. Thus, any particular DSP algorithm selected for use may depend on the exact implementation of the PFC controller itself as some algorithms will work better than others, for example, because a particular algorithm is tightly coupled and interdependent with the PFC controller.

In some implementations, the functionality handled separately by the DSP IC 214 and PFC Controller 212 could be combined in a number of ways. For example, both the PFC controller 212 and the separate DSP IC 214 could be replaced with a custom integrated circuit (a custom IC) that combines the essential elements of the PFC controller IC (IP) 212 along with a suitable microcontroller unit (MCU) or a DSP core, memory, and peripherals as used in the embodiment shown in FIG. 2. Another example embodiment may use a general purpose MCU or DSP IC having additional resources to be able to host a software implementation of both the PFC controller IP and the disclosed novel voltage feedback signal processing DSP code from the embodiment of FIG. 2, together in the same IC as combined IP or separate tasks running in one or separate processing cores. In such an implementation, the digital to analog conversion of the output signal from the DSP to drive the PFC voltage input signal would no longer be required, as the core of the PFC would now be also handled in the digital domain, allowing some simplification of the system to be gained.

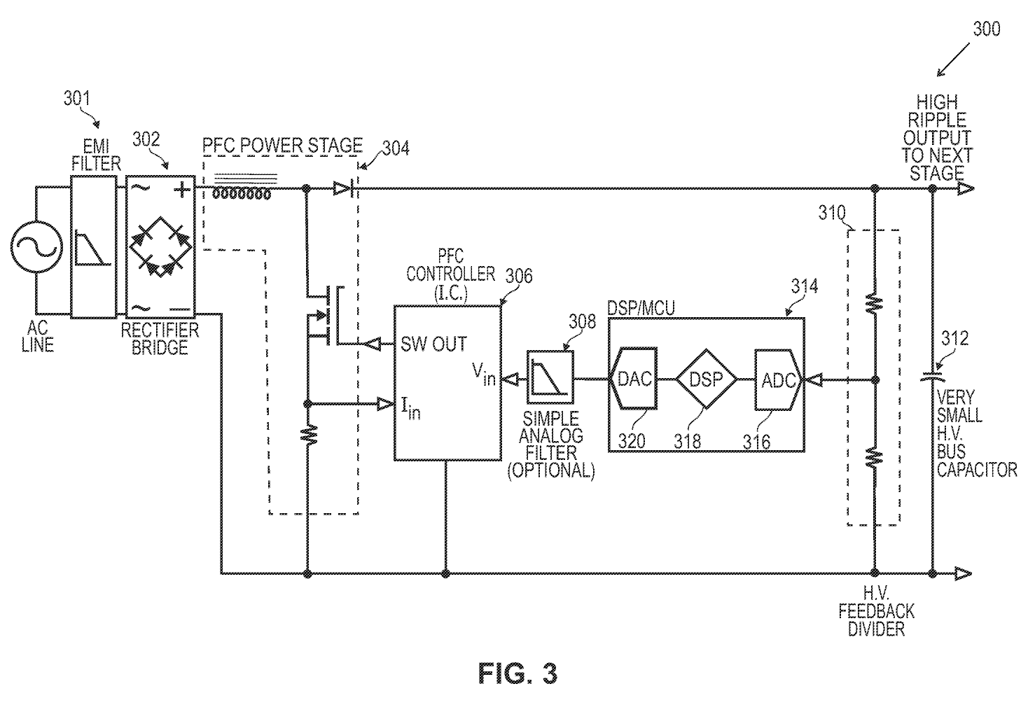

FIG. 3 illustrates another embodiment of a PFC converter circuit 300 in accordance with embodiments of this disclosure. An electromagnetic interference (EMI) filter 301 reduces spurious electromagnetic interference by providing high impedance at high frequencies to block noise from being conducted out to the AC line. Operatively connected to the EMI filter 301 is rectifying bridge circuitry 302 which includes rectifying diodes that operate to convert the incoming AC voltage to a pulsating DC voltage. This 120 Hz pulsating rectified voltage is presented to a PFC power stage 304. The PFC power stage 304 is operatively connected to a PFC controller (shown here as an integrated circuit (IC)) 306, which in turn is operatively connected to an analog filter 308, which may be optional in some implementations. A high-voltage feedback divider circuit 310 is also operatively connected to the PFC power stage 304 and operatively connected to a very small high-voltage bus capacitor 312 (which may be a metallized film capacitor in some implementations). In addition, operatively connected between the PFC controller 306 and the feedback divider circuitry is a digital signal processor (DSP) and/or microcontroller (MCU) 314 which may include an analog-to-digital converter (ADC) circuit 316, a digital signal processing circuit 318, and a digital-to-analog (DAC) circuit 320. In some implementations of the DSP and/or MCU 314, a PFC power factor corrected ADC and/or DAC along with a low cost (e.g., 30 cents) and low pin count microcontroller can be utilized (for example, a Texas Instruments MSPM0™ or equivalent).

Referring again to FIG. 3, the DSP/MCU 314 performs basic digital signal processing functions to implement an arbitrary transfer function using a scaled-down version of the output capacitor 312 bus voltage provided by the divider circuit, the AC line voltage and a zero-crossing digital signal as inputs to the DSP 318 which is running a program or algorithm. In some implementations, the output of the DSP algorithm may be in the form of a digital signal which is converted by the DAC 320 and then fed to the analog filter 308 before being input to the PFC controller 306.

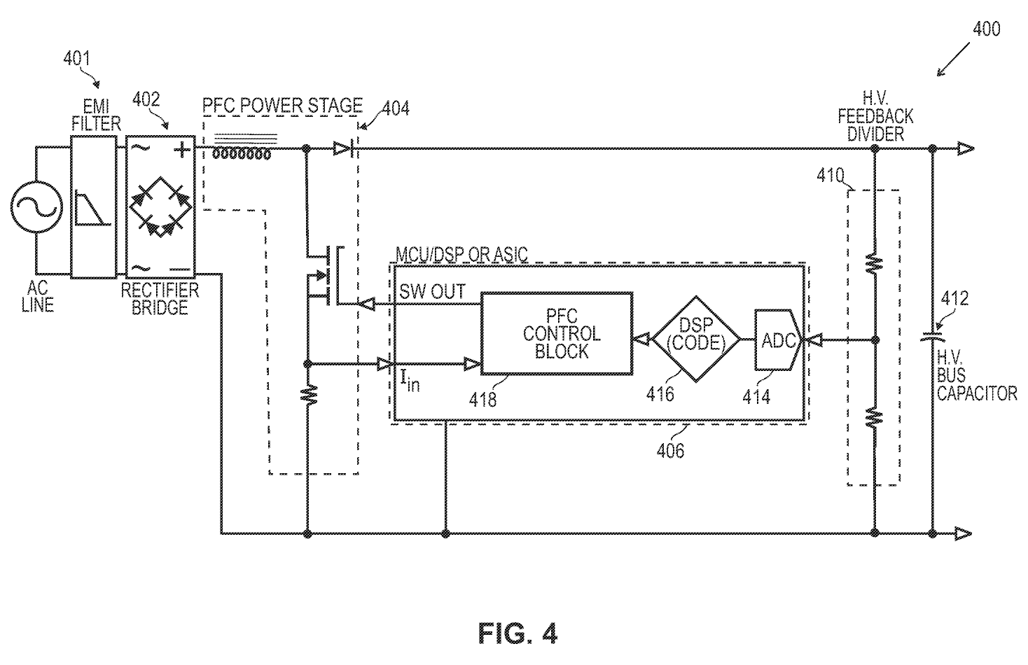

FIG. 4 illustrates yet another embodiment of a PFC converter circuit 400 according to some embodiments of this disclosure. An electromagnetic interference (EMI) filter 401 reduces unwanted electromagnetic interference by providing high impedance at high frequencies to block noise from being conducted out to the AC line. Operatively connected to the EMI filter 401 is rectifying bridge circuitry 402 which includes rectifying diodes that operate to convert the incoming AC voltage to a pulsating DC voltage. This 120 Hz pulsating rectified signal is provided to a PFC power stage 404. The PFC power stage 404 is operatively connected to am MCU/DSP 406 and to a high-voltage feedback divider circuit 410, which in turn is operatively connected to a very small high-voltage bus capacitor 412 (which, in some implementations may be a thin-film capacitor). In the implementation as shown, the MCU/DSP 406 includes an analog-to-digital converter 414, a digital signal process 416 which includes processor executable instructions, and a PFC control block 418. In some implementations, the MCU/DSP 406 is an application-specific integrated circuit (ASIC) specially designed to provide high performance in a smaller package than, for example, a microprocessor.

Referring again to FIG. 4, an analog signal may be fed back from the high voltage feedback divider circuit 410 to the MCU/DSP 406 which is converted from the analog domain to digital signals by the analog-to-digital converter (ADC) 414 and fed to the digital signal process for processing before being output to the PFC control block 418. Thus, the newly processed digital signal is then input to the PFC control block for processing before being output to the PFC power stage 404.

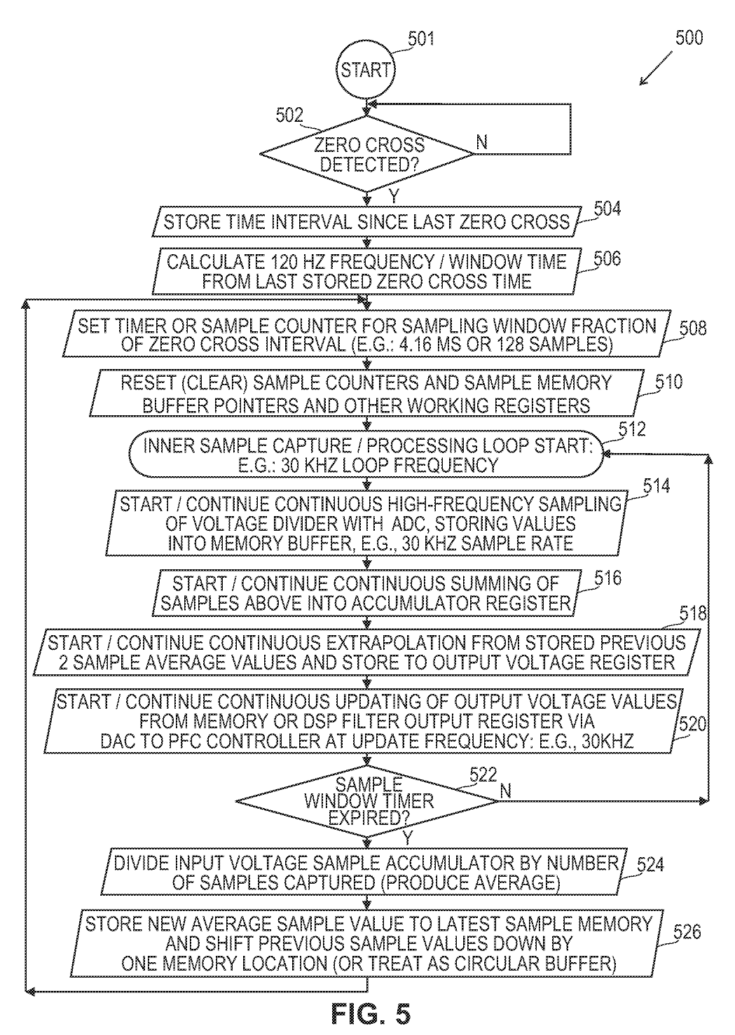

FIG. 5 illustrates an embodiment of a DSP algorithm (or DSP code) 500 in accordance with some embodiments of the disclosure that could be utilized, for example, by the MCU/DSP 406 of the PFC circuit implementation 400 shown in FIG. 4. Referring to FIG. 5, at the start 501 of the DSP core routine execution, the process waits for a zero-crossing to be detected 502 and proceeds immediately once received to store 504 the time the interval since the last zero crossing in a memory. Next, the MCU calculates 506 a 120Hz frequency / window time from the last stored Zero cross time, and then sets 508 a timer or a sample counter for sampling window fraction of zero cross interval, eg. 4.16mS or 128 samples. Next, the MCU resets 510 (or clears) sample counters and sample memory buffer pointers and other working registers, and then starts an inner high-rate sample capture/processing/output loop (512 through 522), for example, at a 30kHz loop frequency. During this loop, the following operations are continuously repeated in sequence or in parallel, until the required number of samples have been processed or the timed interval has elapsed: Digital sampling (via the ADC) of the voltage feedback signal and storage of that value to a memory buffer (514); Summing of same values into an accumulator register (516); extrapolation of equivalent intermediate sample value from previously stored average values and saving the result to an “output voltage” register (518); emitting the stored “output voltage” register value to the DAC, updating the analog output voltage seen by the PFC controller (520).

Upon exiting this loop (steps 512-522), the new average DC value of the processed samples from this time window is obtained by dividing the current accumulated value by the count of samples (524), and this new value is stored in memory, while shifting previous measured values down in memory position by one (or the memory buffer can be treated as a circular buffer) (526). Following this, program control jumps back to the start (step 508), where the sample processing cycle repeats again, or is interrupted (pre-empted) by the next zero-crossing event (502).

Optionally, the above information can be used to allow the algorithm processing cycle to be shorter and more frequent than a zero-crossing interval (typically 8.33mS or 120Hz), for example twice as fast, i.e. 4.16 mS/cycle or 240Hz. Other values may also be used. In addition, a software or hardware timer may be used to set an interrupt or trigger to end/start the signal processing cycle at one or more points in between zero-crossings.

In parallel, a digitized version of the voltage feedback signal may be captured at multiple points during the DSP cycle window (for example, by using an ADC internal or external to the DSP/MCU IC, or ADC equivalent for example using a combination of comparators, timers, and sawtooth signal generated by a constant current source and a resistor). This can happen synchronously or asynchronously with the zero-crossing detection. A sufficiently large number of samples (high enough sampling frequency) should ideally be captured at a precise sampling frequency (from each sampling window) to ensure the accuracy and repeatability of the following processing steps.

In some embodiments, a simple averaging or decimation of the bus voltage values samples taken over the most recent sampling window is performed.

The resulting average value is optionally further processed to obtain an estimated DC voltage value for the most recent sampling window, or can be directly used as such. Further processing can entail a direct or weighted average with previous samples or sample averages taken from previous sampling windows and stored in memory, or extrapolation using sine wave table data for sampling windows smaller than 1/4-cycle.

Alternatively, FIR or IIR type DSP filtering techniques may be used to remove the (120Hz) ripple from the measured voltage feedback divider.

The resulting sequence of estimated or extrapolated / filtered "equivalent" DC voltage values (with little or no 120Hz ripple component remaining) are then used to update the output signal value (also stored in a memory) that will be sent to the PFC controller's voltage feedback input.

Prior to updating the output signal to the PFC controller, the signal may be further smoothed and/or upsampled to a higher frequency or refresh rate, in order to reduce or eliminate the occurrence of sudden large shifts in value which may occur during sudden load changes or during turn-on or turn-off of the circuit, and that may perturb the PFC controller if present beyond a certain limit. This smoothing or upsampling may be accomplished by simple linear or non-linear extrapolation, or some other DSP low-pass filter implementation such as FIR or IIR.

Updating of the output signal value (outputting from the DSP to the PFC controller) may be done with a DAC (digital-to-analog converter) or equivalent. For example, a PMW timer output followed by some analog low-pass filtering may be utilized, or in the case of a digital implementation of the PFC controller, the digital representation may be used directly.

In some alternate embodiments, a different DSP algorithm implementation may seek to directly extract the original slowly varying (non-ripple) AC component of the DC feedback value by taking advantage of available memory in the DSP/MCU to store many or all the samples from one or more of the preceding sampling windows, and then directly subtracting them from the current or most recent sampling window data to generate a "difference" signal, eliminating most or all the 120Hz signal in the process. Depending on the size of the sample window fraction (of a whole 120Hz ripple cycle) used, it may be useful or necessary to effect the comparison/subtraction with one of the sample series in reverse order, or to apply a compensation factor to one or both that varies with the particular sine wave angle/position of the given sample series with respect to the zero crossing.

This "difference" signal can then be summed with the extracted average DC value from the above, to produce a higher-fidelity output signal to send to the PFC controller.

In yet some further embodiments, a sine wave table and fast curve-fitting or similar algorithm may be used to synthesize an equivalent signal to the captured voltage feedback signal which compares the two and treats the resulting difference signal as an error signal. The error signal is then continuously minimized by varying the parameters of the voltage synthesis, for example using a PID loop or similar closed-loop control algorithm.

In such an implementation the values of the parameters of the signal synthesis (such as 120Hz ripple amplitude, average DC value and DC rate of change, etc.,) are then used to synthesize an equivalent signal minus the 120Hz ripple to then output to the PFC controller.

A further variation of this implementation may directly sample and digitize the AC rectified line before the PFC power stage and use those samples instead of or in conjunction with the sine wave table to more accurately generate an equivalent feedback signal including any line voltage or rectifier & EMI filter related distortion that may be present.

In yet some other embodiments, a general purpose MCU or DSP IC could be utilized having additional resources to be able to host a software implementation of both the PFC controller IP and the voltage feedback signal processing DSP code disclosed herein, together in the same IC as combined IP or separate tasks running in one or separate processing cores. In such embodiments, the digital-to-analog conversion of the output signal from the DSP to drive the PFC voltage input signal would no longer be required, as the core of the PFC would now be also handled in the digital domain, advantageously allowing some simplification of the system to be gained.

In summary, disclosed herein are novel PFC converter circuits and methods that, with reference to conventional PFC converter circuits, include additional circuitry and/or an additional module(s) and/or one or more modifications that beneficially enable replacement of the electrolytic capacitor found in conventional PFC converters with a much smaller (on the order of 10 microfarads) film-type capacitor which has a very long operating lifetime. In some embodiments utilizing a small film-type capacitor, one or more additional modules or components may be inserted into the voltage and/or current feedback network of the PFC converter. In other embodiments, an integrated circuit (IC) or system may be utilized which directly controls a PFC power stage without the use of a distinct and separate “dedicated” PFC controller IC or one or more subsystems. In such cases, the IC or system may incorporate digital signal processing hardware and includes processor-executable instructions (i.e., software code) which when executed by the IC (or microprocessor or processor) operates to eliminate or highly attenuate the negative effects of the high 120Hz ripple found on the output and regulation feedback network.

Accordingly, the disclosed PFC converter embodiments may advantageously provide cost and/or space saving benefits when compared to conventional PFC converters because an electrolytic capacitor is not used, nor is one required. Electrolytic capacitors are typically the weakest component link in PFC circuit designs due to their limited lifetime expectancy (typically less than 10 years), high temperature sensitivity, and multiple common failure modes. Thus, implementations disclosed herein replace the electrolytic capacitor with a non-electrolytic capacitor (such as a metallized capacitor) and utilize other and/or additional circuitry and/or middleware and/or software code to ensure that the PFC circuit operates as required. For example, disclosed embodiments may utilize low value, film-type capacitors which have a virtually infinite lifetime. Thus, PFC converters incorporating such film-type capacitors have much better long-term reliability, may be equivalent to or may be smaller in size, and may cost the same or less to manufacture than conventional PFC converters that use electrolytic capacitors.

In addition, the apparatus and methods disclosed herein renders it economically feasible and technologically practical (using commonly available components) to completely eliminate all electrolytic capacitors from LED driver devices or other type of power supply devices without additional penalty in terms of size, cost, or performance degradation. As a result, power supply devices incorporating PFC converter concepts disclosed herein are able to attain much higher levels of reliability and longevity, which would otherwise be limited by the use of conventional PFC converters that utilize electrolytic capacitors.

The above descriptions and/or the accompanying drawings are not meant to imply a fixed order or sequence of steps for any process or method of manufacture referred to herein. Thus, any disclosed process or series of steps depicted in a flowchart may be performed in any order that is practicable, including but not limited to simultaneous performance of one or more steps that are indicated as sequential.

Although the present invention has been described in connection with specific exemplary embodiments, various changes, substitutions, modifications and/or alterations apparent to those skilled in the art can be made to the disclosed embodiments without departing from the spirit and scope of the invention as set forth in the appended claims.

What is claimed is:

1. A Power Factor Correction (PFC) circuit, comprising:
a rectifier bridge circuit;
a PFC power stage operably connected to the rectifier bridge circuit;
a PFC control segment operably connected to the PFC power stage and to a high-voltage feedback divider; and
a small value, high-voltage capacitor operatively connected to the high-voltage feedback divider and the PFC power stage;
wherein the PFC control segment comprises a PFC controller and a digital signal processor (DSP), and wherein the DSP is configured to:
convert an high AC ripple feedback signal received from the high-voltage feedback divider to a digital high ripple feedback digital signal;
transform the digital high ripple feedback digital signal to a suitable low-ripple feedback signal;
convert the digital low-ripple feedback signal to an AC low-ripple feedback signal; and
input the analog low-ripple feedback signal to the PFC control segment enabling the PFC circuit to operate correctly and reliably.

2. The PFC circuit of claim 1, wherein the PFC control segment further comprises a low bandwidth filter operatively connected between the DSP and the PFC controller.

3. The PFC circuit of claim 2, wherein the PFC controller comprises an integrated circuit (IC) controller.

4. The PFC circuit of claim 1, wherein the small value, high-voltage capacitor is a metallized capacitor.

5. The PFC circuit of claim 1, wherein the PFC control segment further comprises:
an analog-to-digital converter (ADC) operably connected between the high-voltage feedback divider and the DSP; and
a digital-to-analog converter (DAC) operably connected between the DSP and the PFC controller.

6. The PFC circuit of claim 5, wherein the ADC, DSP and DAC comprise one of a DSP controller, a microprocessor control unit (MCU), or an application specific integrated circuit (ASIC).

7. The PFC circuit of claim 5, further comprising an analog filter operatively connected between the DAC and the PFC controller.

8. A method for operating a Power Factor Correction (PFC) device having a small value output capacitor, comprising:
receiving, by a digital signal processor (DSP) from a high-voltage feedback divider circuit, a high AC ripple feedback signal generated by a small value output capacitor;
converting, by the DSP, the high AC ripple feedback signal to a digital high ripple feedback digital signal;
transforming, by the DSP, the digital high ripple feedback digital signal to a suitable low-ripple feedback signal;
converting, by the DSP, the digital low-ripple feedback signal to an analog low-ripple feedback signal; and
outputting, by the DSP to a PFC control segment, the analog low-ripple feedback signal enabling the PFC device to operate correctly and reliably.

9. A non-transitory computer-readable medium storing instructions which when executed by a digital signal processor (DSP) of a Power Factor Correction (PFC) device that utilizes a small value output capacitor, causes the DSP to:
receive, from a high-voltage feedback divider circuit of the PFC device, a high AC ripple feedback signal generated by a small value output capacitor;
convert the high AC ripple feedback signal to a digital high ripple feedback digital signal;
transform the digital high ripple feedback digital signal to a suitable low-ripple feedback signal;
convert the digital low-ripple feedback signal to an analog low-ripple feedback signal; and
output the analog low-ripple feedback signal to a PFC control segment of the PFC device enabling the PFC device to operate correctly and reliably.
